(19) United States
(12) Patent Application Publication
(10) Pub. No.: US 2025/0354416 A1
(43) Pub. Date: Nov. 20, 2025

(54) DOUBLE-STROKE LOCKING SYSTEM WITH QUICK RELEASE

(71) Applicant: AUDI AG, Ingolstadt (DE)

(72) Inventors: André SCHUBERT, Ingolstadt (DE); Thomas LIEPOLD, Gaimersheim (DE)

(73) Assignee: AUDI AG, Ingolstadt (DE)

(21) Appl. No.: 19/189,523

(22) Filed: Apr. 25, 2025

(30) Foreign Application Priority Data
May 14, 2024 (DE) 102024113350.3

(51) Int. Cl. E05B 81/14; E05B 81/06

(52) U.S. Cl. CPC E05B 81/14; E05B 81/06

(57) ABSTRACT

A double-stroke locking system includes a rotary latch, a locking pawl and a drive mechanism. The rotary latch has a receiving region which is designed to receive a locking element, and the locking pawl is designed to lock the rotary latch in at least one rotational position. The locking pawl has an actuating lever and can be moved into an unlocking position or into a locking position by the actuating lever. The actuating lever can be connected to a drive mechanism and can be decoupled from the drive mechanism by performing a first unlocking stroke by the drive mechanism.

### FIELD

The invention relates to a double-stroke locking system comprising a rotary latch, a locking pawl and a drive mechanism, wherein the rotary latch has a receiving region which is designed to receive a locking element. Furthermore, the invention relates to a method.

### BACKGROUND

In the vehicle sector, so-called double-stroke locking devices or double-stroke locking systems are used to be able to open a lockable element from two different positions. For example, the lock of a trunk, side doors and front hood of vehicles may be designed in the form of a double-stroke locking system and can be opened by means of an internal drive or lever and by operating a lever or handle. Such locking systems usually have a rotary latch that can be prevented from rotating by a locking pawl. Typically, the locking pawl can be spaced from the rotary latch by a release mechanism to allow the locking system to be closed. The problem, however, is that the speed with which the locking pawl can block the rotary latch again after opening and thus allow the locking system to close depends on the return speed of the unlocking mechanism and is therefore subject to a time delay.

DE 10 2021 128 302 A 1 describes an electrically operated motor vehicle lock. DE 10 2022 106 182 A 1 also describes a motor vehicle lock with a lock latch and a locking pawl.

### SUMMARY

It is the object of the present invention to provide a locking system which can be locked again after unlocking with a minimal time delay.

The double-stroke locking system according to the invention has a rotary latch, a locking pawl and a drive mechanism. The drive mechanism can be operated electrically and/or manually to unlock the locking system. The double-stroke locking system can be unlocked from several different locations.

The rotary latch has a receiving region which is designed to receive a locking element. The locking element can be a locking bolt or a locking bracket. The locking element can be arranged, for example, on a door or a flap, which can be held in a locking position by the rotary latch.

The locking pawl is designed to lock the rotary latch in at least one rotational position. The locking pawl can be tilted relative to the rotary latch to block or release rotation of the rotary latch in one direction. This allows the rotary latch to receive the locking element into the receiving region or release it from the receiving region, depending on the tilting position of the locking pawl.

The locking pawl has an operating lever and can be moved into an unlocking position or a locking position by the operating lever. In the unlocking position, the tilting position of the locking pawl allows the locking element to be received in the receiving region of the rotary latch. In the locking position, the tilting position of the locking pawl prevents the locking element from being released from the receiving region of the rotary latch.

The operating lever can be connected to a drive mechanism, wherein the operating lever can be decoupled from the drive mechanism by completing a first unlocking stroke.

The drive mechanism is designed to perform one or more unlocking strokes.

According to a further aspect of the invention, a method for operating a locking system according to the invention is provided. In one step of the process, the drive mechanism is manually operated or electrically driven when the locking element is inserted and locked in the receiving region of the rotary latch. This causes the drive mechanism to perform a first unlocking stroke. A driver of the drive mechanism can be pushed or pulled against the actuating lever of the locking pawl so that the tilting position of the locking pawl is changed. After the first unlocking stroke has been completed, the driver is released or spaced from the operating lever. This measure can be achieved, for example, by sliding or twisting of the driver of the drive mechanism.

By completing a second unlocking stroke through the drive mechanism, the driver can be moved past the actuating lever into its original position or basic state. The first unlocking stroke can be opposite to the second unlocking stroke.

The locking system is faster than conventional double-stroke locking mechanisms because the drive mechanism is disengaged from the locking pawl immediately after the first unlocking stroke is completed, meaning that the return speed of the locking pawl is no longer dependent on the return speed of the unlocking mechanism or the drive mechanism. With conventional double-action locking devices, for example, it is not possible to reset the locking pawl and lock the rotary latch if a user does not release the unlocking lever or the drive mechanism. The locking system according to the invention enables here a direct and fast locking of the rotary latch by the locking pawl, even if the drive mechanism is still actuated.

In one exemplary embodiment, the actuating lever can be moved into an unlocking position by a rotatable driver of the drive mechanism, wherein after the first unlocking stroke, the actuating lever can be decoupled from the drive mechanism by the driver sliding off the actuating lever. After the first unlocking stroke has been carried out, the locking pawl can be disengaged from the drive mechanism so that the locking system can immediately be locked again or can fully unlock into the secure position without having to wait for the drive mechanism to reach its initial position.

According to a further embodiment, the driver can be moved into a basic position by the drive mechanism after actuating a second unlocking stroke, wherein in the basic position of the driver the actuating lever is coupled to the drive mechanism. This measure allows the locking system to be moved into the open position after the second unlocking stroke has been carried out. This state of the locking system again forms the initial state in which the driver is positioned in the basic position. In this state of the locking system, the drive mechanism may be deactivated or not operated.

According to a further exemplary embodiment, at least one blocking lever is provided, wherein the blocking lever is designed to interact positively with a control contour of the rotary latch. This measure allows the locking pawl to be held in the unlocking position or in the locking position by the blocking lever along certain regions on the outer contour of the rotary latch.

According to a further embodiment, the blocking lever has a blocking section, wherein the blocking section is designed to fix the driver of the drive mechanism and/or the actuating lever of the locking pawl, wherein the driver and/or the actuating lever can be fixed by the blocking section in a state of the blocking lever deflected by the control contour. This allows the blocking lever to be designed in a particularly simple technical manner. If the blocking lever is deflected by the control contour or spaced from the rotary latch, the possible movement of the driver and/or the actuating lever of the locking pawl can be blocked or restricted.

In particular, the blocking section can block a transition of the driver from the first unlocking stroke to the second unlocking stroke. Depending on the design, completion of the first unlocking stroke can be prevented alternatively or additionally, thereby preventing decoupling of the locking pawl from the drive mechanism.

The blocking lever can, for example, differentiate the physically existing unlocking state of the locking system via a guide contour or control contour located on the rotary latch, which, when inserted, blocks the release of the locking pawl after the unlocking stroke has been carried out.

According to a further exemplary embodiment, a deflection of the blocking lever can be reset after a rotation of the rotary latch and the driver and/or the actuating lever can be released. This allows the effect of the blocking section to be canceled after the locking element has been inserted into the receiving section of the rotary latch, resulting in rotation of the rotary latch. In particular, the deflection of the blocking lever can be reversed.

According to a further embodiment, the locking pawl and/or the rotary latch and/or the blocking lever are spring-loaded, wherein the rotary latch is arranged to rotate about a first axis of rotation and the locking pawl is arranged to rotate about a second axis of rotation and the blocking lever is arranged to rotate about the second axis of rotation. This measure allows the locking system to be particularly compact. The spring-loaded bearing enables optimal interaction of the locking pawl and the blocking lever with the rotary latch.

According to a further exemplary embodiment, the driver is rotatable about a drive axis until it stops on a first guide and is linearly movable along the first guide during the first unlocking stroke of the drive mechanism. The drive axis can be aligned perpendicular to the first axis of rotation and the second axis of rotation. The first guide can run parallel to the drive axis.

Preferably, after the first unlocking stroke has been carried out, the driver can slide from the first guide into a second guide running parallel to the first guide. This sliding of the driver can also decouple the actuating lever and thus the locking pawl from the driver and thus from the drive mechanism.

During the second unlocking stroke, the driver can be moved along the second guide up to a basic setting. This allows the driver to be moved back to the basic position or the original position.

According to a further embodiment, the driver is adjustable along the first guide in a first rotational position and along the second guide in a second rotational position. The two guides can limit the rotation of the driver in defined rotational positions. Optimally, the driver can be moved along the drive axis by the first unlocking stroke in a linear direction opposite to the second unlocking stroke. During the second unlocking stroke, the driver can be easily guided past the actuating lever. The drive mechanism remains decoupled from the locking pawl during the second unlocking stroke.

### BRIEF DESCRIPTION OF THE FIGURES

The invention is schematically illustrated in the drawings with the aid of embodiments and is described further with reference to the drawings. In the figures:

FIG. 1 shows a side sectional view of a double-stroke locking system according to an exemplary embodiment of the invention.

FIG. 2 shows a perspective view of a drive mechanism of the locking system from FIG. 1 to illustrate an effect on an operating lever.

FIG. 3 shows a side sectional view of a blocking lever of a locking system according to a further exemplary embodiment of the invention.

Elements and components with the same or similar structural or functional features are provided with the same reference numerals throughout the figures.

### DETAILED DESCRIPTION

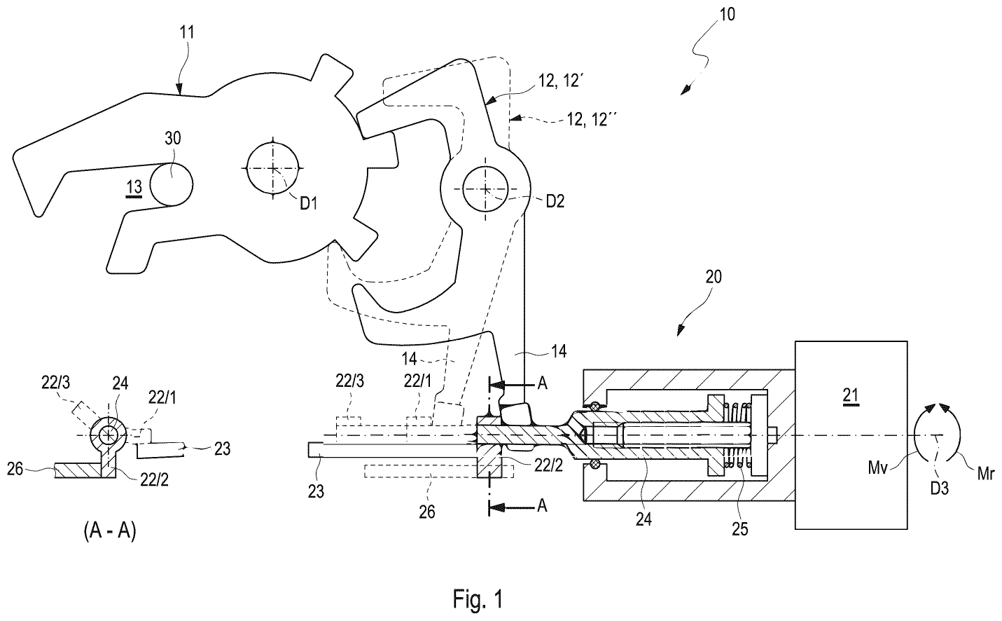

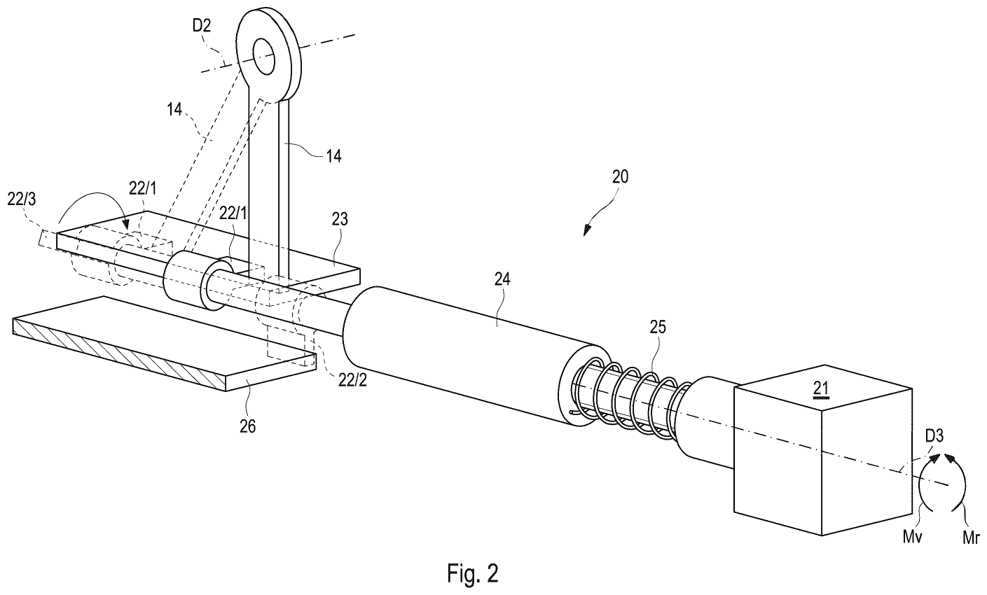

FIG. 1 shows a side sectional view of a double-stroke locking system 10 according to an exemplary embodiment of the invention. In support of this, reference is made to FIG. 2, which shows a perspective view of a drive mechanism 20 of the locking system 10 from FIG. 1 to illustrate an effect on an actuating lever.

The locking system 10 is preferably configured to carry out a method according to the invention for operating the locking system 10. This procedure is illustrated using the figures.

The double-stroke locking system 10 has a rotary latch 11, a locking pawl 12 and a drive mechanism 20. In the illustrated exemplary embodiment, the drive mechanism 20 can be operated electrically and manually to unlock the locking system 10. For electrical actuation, the drive mechanism 20 has a drive 21 in the form of an electric motor. The drive 21 of the drive mechanism 20 can be controlled in a forward direction Mv or in a reverse direction M r.

The rotary latch 11 has a receiving region 13, which is designed to receive a locking element 30. The locking element 30 is designed, for example, as a locking bracket.

The locking pawl 12 is designed to lock the rotary latch 11 in at least one rotational position. The locking pawl 12 can be tilted relative to the rotary latch 11 to block or release rotation of the rotary latch 11 in one direction. This allows the rotary latch 11 to receive the locking element 30 into the receiving region 13 or release it from the receiving region 13, depending on the tilting position of the locking pawl 12.

The locking pawl 12 has an operating lever 14 and can be moved into an unlocking position or a locking position by the operating lever 14. The locking pawl 12 is shown as an example in an unlocking position 12′ and the locking pawl 12 is shown as an example in a locking position 12″.

In the unlocking position 12′ of the locking pawl 12, the locking element 30 can be received in the receiving region 13 of the rotary latch 11. In the locking position 12″, the tilting position of the locking pawl 12 prevents the locking element 30 from being released from the receiving region 13 of the rotary latch 11.

The operating lever 14 can be connected to a drive mechanism 20, wherein the operating lever 14 can be decoupled from the drive mechanism 20 by completing a first unlocking stroke 1. In this case, a driver 22 of the drive mechanism 20 can be pulled against the actuating lever 14 of the locking pawl 12.

In the figures, the driver 22/1 is visualized during the first unlocking stroke 1, the driver 22/2 during a second unlocking stroke 2 and the driver 22/3 in the basic position 3 in order to illustrate the movement sequences of the driver 22.

Such a linear movement of the driver 22 occurs in the direction of a drive axis D3. The driver 22 is rotated from a basic position 3 around the drive axis D3 by the drive 21 in the forward direction M v and pulled in the direction of the drive 21 along the drive axis D3. The rotation and the linear movement of the driver 22 can be carried out, for example, by means of a spindle 24 spring-loaded by means of a spring 25.

During the first unlocking stroke 1 of the drive mechanism 20, the driver 22 is rotatable about the drive axis D3 until it stops on a first guide 23 and is movable linearly along the first guide 23. The first guide 23 runs parallel to the drive axis D3.

The tilting position of the locking pawl 12 is changed along the guide 23 by pulling of the operating lever 14. After the first unlocking stroke 1 has been completed, the driver 22 is released or spaced from the operating lever 14. This transition occurs, for example, by sliding or rotating of the driver 22 of the drive mechanism 20. At the end of the first unlocking stroke 1, the first guide 23 does not run any further, so that the driver 22 can be rotated further by means of the spring force of the spring 25. As a result, the driver 22 slides off the actuating lever 14 and decouples it. The rotation of the driver 22 is then stopped by a second guide 26, which runs parallel to the first guide 23.

The driver 22 can be brought into a basic setting 3 or initial position when the drive 21 is operated in the reverse direction Mr, so that the driver 22 is moved along the second guide 26 during the second unlocking stroke 2.

The respective positions of the driver 22 and the corresponding alignments relative to the guides 23, 26 during the first unlocking stroke 1, the second unlocking stroke 2 and in the basic setting 3 are illustrated in section A-A.

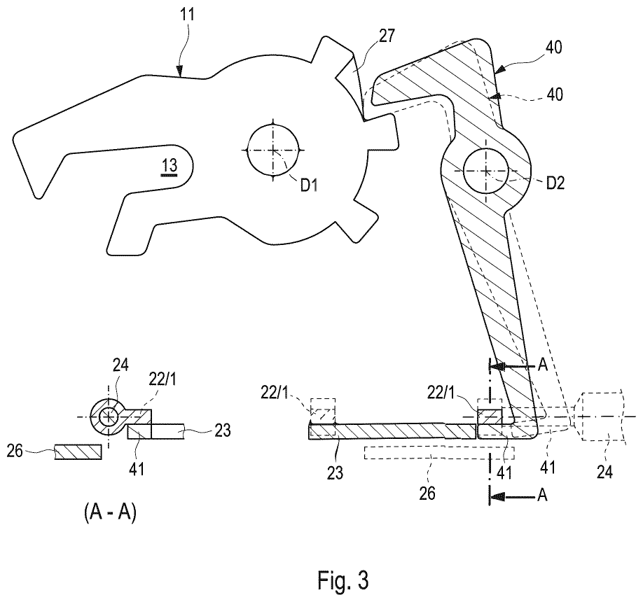

FIG. 3 shows a side sectional view of a blocking lever 40 of the locking system 10 according to a further exemplary embodiment of the invention. The blocking lever 40 is designed to interact positively with a control contour 27 of the rotary latch 11. This measure allows the locking pawl 12 to be held in the unlocking position or in the locking position by the blocking lever 40 along certain regions on the outer contour of the rotary latch.

The rotary latch 11 is arranged to rotate about a first axis of rotation D1 and the locking pawl 12 about a second axis of rotation D2. The blocking lever 40 is also arranged to be rotatable about the second axis of rotation D2.

The blocking lever 40 has a blocking section 41 which is designed to fix the driver 22 of the drive mechanism 20 and/or the actuating lever 14 of the locking pawl 12. If the blocking lever 40 is deflected by the control contour 27 or spaced from the rotary latch 11, the possible movement of the driver 22 and/or the actuating lever 14 of the locking pawl 12 can be blocked or restricted.

In the illustrated exemplary embodiment, the blocking section 41 blocks the rotational movement of the driver 22 to complete the first unlocking stroke 1. This prevents the rotation of the driver 22 up to the second guide 26. Thus, the actuating lever 14 cannot be decoupled from the drive mechanism 20.

### LIST OF REFERENCE NUMERALS

1 first unlocking stroke
2 second unlocking stroke
3 basic setting/initial position
10 locking system/double-stroke locking system
11 rotary latch
12 locking pawl
13 receiving region
14 actuating lever
20 drive mechanism
21 drive
22 driver
23 first guide
24 spindle
25 spring
26 second guide
27 control contour
30 locking element
40 blocking lever
41 blocking section
D3 drive axis
D1 first axis of rotation
D2 second axis of rotation
Mv forward direction
Mr reverse direction

1. A double-stroke locking system, comprising: a rotary latch, a locking pawl and a drive mechanism, wherein the rotary latch has a receiving region which is designed to receive a locking element, and wherein the locking pawl is designed to lock the rotary latch in at least one rotational position, wherein the locking pawl has an actuating lever and can be moved into an unlocking position or into a locking position by the actuating lever, wherein the actuating lever can be connected to a drive mechanism, wherein the actuating lever can be decoupled from the drive mechanism by performing a first unlocking stroke by the drive mechanism.

2. The locking system according to claim 1, wherein the actuating lever can be moved into an unlocking position by a rotatable driver of the drive mechanism, wherein, after the first unlocking stroke, the actuating lever can be decoupled from the drive mechanism by the driver sliding off the actuating lever.

3. The locking system according to claim 2, wherein the driver can be moved into a basic position by the drive mechanism after actuation of a second unlocking stroke, wherein, in the basic position of the driver, the actuating lever is coupled to the drive mechanism.

4. The locking system according to claim 1, wherein the locking system has at least one blocking lever, wherein the blocking lever is designed to interact with a positive fit with a control contour of the rotary latch.

5. The locking system according to claim 4, wherein the blocking lever has a blocking section, wherein the blocking section is designed to fix the driver of the drive mechanism and/or the actuating lever of the locking pawl, wherein the driver and/or the actuating lever can be fixed by the blocking section in a state of the blocking lever deflected by the control contour.

6. The locking system according to claim 4, wherein a deflection of the blocking lever can be reset after rotation of the rotary latch and the driver and/or the actuating lever can be released.

7. The locking system according to claim 1, wherein the locking pawl and/or the rotary latch and/or the blocking lever are spring-loaded, wherein the rotary latch is arranged to be rotatable about a first axis of rotation and the locking pawl is arranged to be rotatable about a second axis of rotation and the blocking lever is arranged to be rotatable about the second axis of rotation.

8. The locking system according to claim 2, wherein the driver is rotatable about a drive axis until it stops on a first guide and is linearly movable along the first guide during the first unlocking stroke of the drive mechanism, wherein the driver can slide from the first guide into a second guide running parallel to the first guide after the first unlocking stroke has been carried out, wherein the driver can be moved along the second guide until it reaches a basic setting during the second unlocking stroke.

9. The locking system according to claim 8, wherein the driver is adjustable in a first rotational position along the first guide and wherein the driver is adjustable in a second rotational position along the second guide, wherein the first unlocking stroke is movable in a linear direction opposite to the second unlocking stroke along the drive axis.

10. A method for operating a locking system, wherein a drive mechanism is actuated and a first unlocking stroke is carried out, wherein during the first unlocking stroke a driver of the drive mechanism moves a locking pawl via an actuating lever from a first tilting position into a second tilting position, wherein after the end of the first unlocking stroke the driver is decoupled from the actuating lever.

11. The locking system according to claim 2, wherein the locking system has at least one blocking lever, wherein the blocking lever is designed to interact with a positive fit with a control contour of the rotary latch.

12. The locking system according to claim 3, wherein the locking system has at least one blocking lever, wherein the blocking lever is designed to interact with a positive fit with a control contour of the rotary latch.

13. The locking system according to claim 5, wherein a deflection of the blocking lever can be reset after rotation of the rotary latch and the driver and/or the actuating lever can be released.

14. The locking system according to claim 2, wherein the locking pawl and/or the rotary latch and/or the blocking lever are spring-loaded, wherein the rotary latch is arranged to be rotatable about a first axis of rotation and the locking pawl is arranged to be rotatable about a second axis of rotation and the blocking lever is arranged to be rotatable about the second axis of rotation.

15. The locking system according to claim 3, wherein the locking pawl and/or the rotary latch and/or the blocking lever are spring-loaded, wherein the rotary latch is arranged to be rotatable about a first axis of rotation and the locking pawl is arranged to be rotatable about a second axis of rotation and the blocking lever is arranged to be rotatable about the second axis of rotation.

16. The locking system according to claim 4, wherein the locking pawl and/or the rotary latch and/or the blocking lever are spring-loaded, wherein the rotary latch is arranged to be rotatable about a first axis of rotation and the locking pawl is arranged to be rotatable about a second axis of rotation and the blocking lever is arranged to be rotatable about the second axis of rotation.

17. The locking system according to claim 5, wherein the locking pawl and/or the rotary latch and/or the blocking lever are spring-loaded, wherein the rotary latch is arranged to be rotatable about a first axis of rotation and the locking pawl is arranged to be rotatable about a second axis of rotation and the blocking lever is arranged to be rotatable about the second axis of rotation.

18. The locking system according to claim 6, wherein the locking pawl and/or the rotary latch and/or the blocking lever are spring-loaded, wherein the rotary latch is arranged to be rotatable about a first axis of rotation and the locking pawl is arranged to be rotatable about a second axis of rotation and the blocking lever is arranged to be rotatable about the second axis of rotation.

19. The locking system according to claim 3, wherein the driver is rotatable about a drive axis until it stops on a first guide and is linearly movable along the first guide during the first unlocking stroke of the drive mechanism, wherein the driver can slide from the first guide into a second guide running parallel to the first guide after the first unlocking stroke has been carried out, wherein the driver can be moved along the second guide until it reaches a basic setting during the second unlocking stroke.

20. The locking system according to claim 4, wherein the driver is rotatable about a drive axis until it stops on a first guide and is linearly movable along the first guide during the first unlocking stroke of the drive mechanism, wherein the driver can slide from the first guide into a second guide running parallel to the first guide after the first unlocking stroke has been carried out, wherein the driver can be moved along the second guide until it reaches a basic setting during the second unlocking stroke.
